(19) United States
(12) Patent Application Publication
(10) Pub. No.: US 2011/0273397 A1
(43) Pub. Date: Nov. 10, 2011

(54) ORGANIC EL DISPLAY DEVICE AND METHOD FOR DETECTING TOUCH

(75) Inventor: Jun HANARI, Kanazawa-Shi (JP)

(73) Assignee: Toshiba Mobile Display Co., Ltd., Fukaya-Shi (JP)

(21) Appl. No.: 13/039,682

(22) Filed: Mar. 3, 2011

(30) Foreign Application Priority Data
May 6, 2010 (JP) 2010-106603

(51) Int. Cl. G06F 3/041; G09G 3/30

(52) U.S. Cl. 345/174; 345/76

(57) ABSTRACT

According to one embodiment, an organic EL display device has a pixel circuit on a first substrate and a touch detection circuit adjacent to the pixel circuit on the first substrate. The pixel circuit has an organic EL light-emitting element configured to emit light having brightness depending on a pixel voltage supplied by a pixel signal line, a drive element configured to drive the organic EL light-emitting element, and a first select element configured to supply the pixel voltage to the drive element in synchronization with a control signal supplied by a control signal line. The touch detection circuit has a touch detection capacitor configured to detect a presence/absence of a touch of a dielectric and a second select element configured to output a signal indicative of the presence/absence of the touch of the dielectric detected by the touch detection capacitor to an electrostatic signal line in synchronization with the control signal supplied by the control signal line.

### CROSS REFERENCE TO RELATED APPLICATIONS

This application is based upon and claims the benefit of priority from the prior Japanese Patent Application No. 2010-106603, filed on May 6, 2010, the entire contents of which are incorporated herein by reference.

### FIELD

Embodiments described herein relate generally to an organic EL display device and a method for detecting touch.

### BACKGROUND

In recent years, a display device having a touch detection function has been used in many electronic devices in order to improve operability, to reduce cost by reducing the number of buttons, and to reduce size and weight.

When the display device is a liquid crystal display, it is general that a touch panel is superposed on the liquid crystal display. This is because it is difficult to incorporate a circuit for detecting touch into the liquid crystal display since liquid crystal is filled in the liquid crystal display. Even if the integration is achieved, the circuit configuration of the display device may be more complicated since it is necessary to add a new signal for control read operation in order to read presence/absence of the touch in a video blanking period.

Further, many organic EL display devices have been proposed in recent years (patent documents 1 to 3, for example). However, in these documents, employment of the touch detection function is not taken into consideration at all. It is necessary to arrange a separated touch panel in order to add the touch detection function, which leads to a problem that component cost is considerably increased.

### BRIEF DESCRIPTION OF THE DRAWINGS

FIG. 1 is a circuit configuration of a pixel 100 in an organic EL display device according to a first embodiment.

FIG. 2 is a timing chart showing an example of the operation of the pixel 100.

FIG. 3 is a diagram showing an example of a layout pattern of the pixel 100 of FIG. 1.

FIG. 4 is a circuit configuration of a pixel 101 in an organic EL display device according to a second embodiment.

FIG. 5 is a timing chart showing an example of the operation of the pixel 101.

FIG. 6 is a diagram showing an example of the layout pattern of the pixel 101 of FIG. 4.

FIG. 7 is a circuit configuration of a pixel 102 in an organic EL display device according to a third embodiment.

FIG. 8 is a timing chart showing an example of the operation of the pixel 102.

FIG. 9 is a timing chart showing another example of the operation of the pixel 102.

FIG. 10 is a diagram showing an example of the layout pattern of the pixel 102 of FIG. 7.

FIG. 11 is a circuit configuration of a pixel 103 in an organic EL display device according to a fourth embodiment.

FIG. 12 is a timing chart showing an example of the operation of the pixel 103.

FIG. 13 is a timing chart showing another example of the operation of the pixel 103.

FIG. 14 is a circuit configuration of a pixel 104 in an organic EL display device according to the fifth embodiment.

FIG. 15 is a timing chart showing an example of the operation of the pixel 104.

FIG. 16 is a sectional view of the organic EL display device according to each embodiment.

FIG. 17 is a sectional view of an organic EL display device in a modification example.

FIG. 18 is a sectional view of an organic EL display device in another modification example.

### DETAILED DESCRIPTION

In general, according to one embodiment, an organic EL display device has a pixel circuit on a first substrate and a touch detection circuit adjacent to the pixel circuit on the first substrate. The pixel circuit has an organic EL light-emitting element configured to emit light having brightness depending on a pixel voltage supplied by a pixel signal line, a drive element configured to drive the organic EL light-emitting element, and a first select element configured to supply the pixel voltage to the drive element in synchronization with a control signal supplied by a control signal line. The touch detection circuit has a touch detection capacitor configured to detect a presence/absence of a touch of a dielectric and a second select element configured to output a signal indicative of the presence/absence of the touch of the dielectric detected by the touch detection capacitor to an electrostatic signal line in synchronization with the control signal supplied by the control signal line.

Embodiments will now be explained with reference to the accompanying drawings.

### First Embodiment

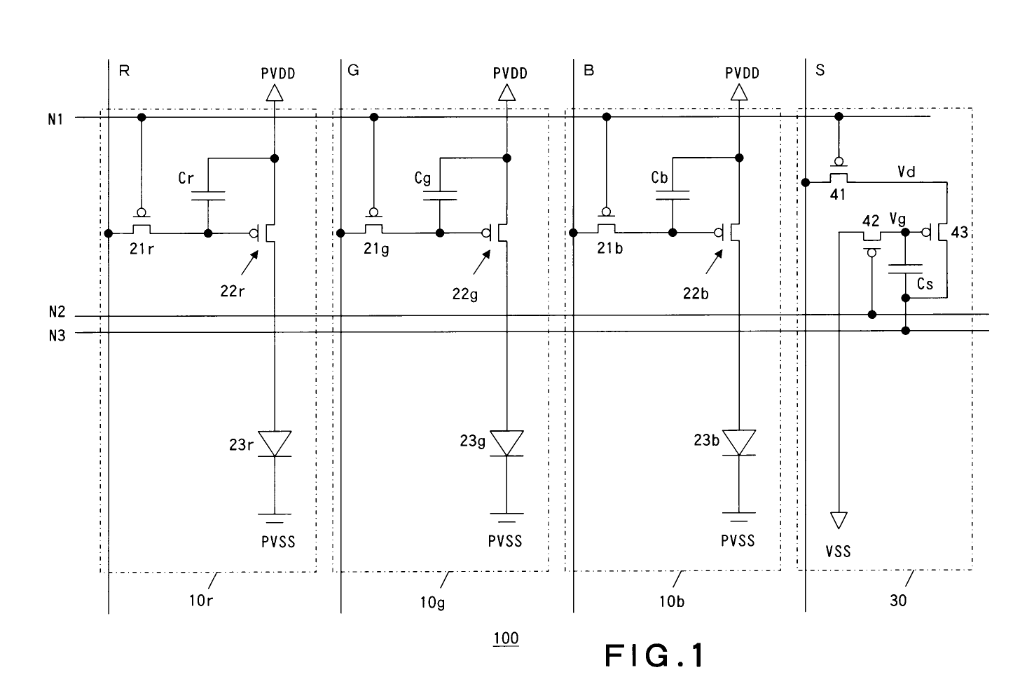

FIG. 1 is a circuit configuration of a pixel 100 in an organic EL display device according to a first embodiment. The pixel 100 of FIG. 1 has an R pixel circuit 10r, a G pixel circuit 10g, a B pixel circuit 10b and a touch detection circuit 30. These circuits are formed on the same substrate (such as a glass substrate). Further, pixel voltages R, G, B are inputted from pixel signal lines R, G, B, respectively, and control signals N1 to N3 are inputted from control signal lines N1 to N3, respectively. Furthermore, a voltage (signal) indicative of presence/absence of touch is outputted from an electrostatic signal line S.

The organic EL display device is formed of a plurality of pixels 100 arranged in a matrix form. Further, the control signal lines N1 to N3 are shared among all pixels in the N-th line. The control signals N1 to N3 are set high or low by a control circuit (not shown) arranged outside the pixel 100.

The R pixel circuit 10r has a P-type select TFT (Thin Film Transistor) 21r, a P-type drive TFT 22r, a pixel capacitor Cr and an organic EL light-emitting element 23r. The TFT 22r and the light-emitting element 23r are connected in series between a power source line PVDD and a power source line PVSS. The pixel capacitor Cr is connected between the power source line PVDD and the gate of the TFT 22r. The TFT 21r is connected between the pixel signal line R and the gate of the TFT 22r, and the gate thereof is supplied with the control signal N1.

A power supply voltage VDD (not shown) of the pixel circuits 10r, 10g, 10b and the control circuit is 0V to 10V, for example, and a power supply voltage VSS is −5V to 5V, for example. Note that the voltages should be set so that VDD>VSS. High of the control signals N1 to N3 corresponds to the power supply voltage VDD, and low corresponds to the power supply voltage VSS. Further, a power supply voltage PVDD supplied to the light-emitting elements 23r, 23g, 23b is 5V to 15V, for example, and a power supply voltage PVSS is −5V to 5V, for example. The voltage is properly set within this range depending on a design factor such as TFT characteristics.

These power supply voltages may be supplied directly from the outside, or may be generated by using a level shift circuit (not shown).

When the control signal N1 of FIG. 1 supplied through the control signal line N1 is set low, the TFT 21r (first select element) is turned on to supply the pixel voltage R to the pixel capacitor Cr and the gate of the TFT 22r. The TFT 22r (driver element) supplies, to the light-emitting element 23r, drive current depending on the supplied pixel voltage R. The light-emitting element 23r emits red light having brightness depending on the drive current.

The internal structures of the G pixel circuit 10g and the B pixel circuit 10b are similar to the R pixel circuit 10r excepting that the light-emitting element 23g emits green light and the light-emitting element 23b emits blue light. Therefore, the explanation thereof will be omitted.

The touch detection circuit 30 of FIG. 1 is a capacitance-type touch detection circuit. More specifically, voltage of a predetermined internal node changes when a dielectric such as a fingertip approaches the organic EL display device, and the touch detection circuit 30 detects the presence/absence of the touch by catching the change.

The touch detection circuit 30 has a P-type select TFT 41, a P-type pre-charge TFT 42, a P-type capacitance detection TFT 43 and a touch detection capacitor Cs. The TFTs 41 and 43 are connected in series between the electrostatic signal line S and the control signal line N3. The gate of the TFT 41 is supplied with the control signal N1. The capacitor Cs is connected between the gate of the TFT 43 and the source thereof. The TFT 42 is connected between the gate of the TFT 43 and a power source line VSS. The gate of the TFT 42 is supplied with the control signal (pre-charge signal) N2 through the control signal line (pre-charge signal line) N2.

When the control signal N2 is set low, the TFT 42 is turned on and the capacitor Cs and the gate of the TFT 43 are charged at the power supply voltage VSS. The TFT 43 detects the presence/absence of the touch. More specifically, a drain voltage Vd of the TFT 43 depends on the presence/absence of the touch of the dielectric, as will be explained later. When the control signal N1 supplied through the control signal line N1 is set low, the TFT 41 (second select element) outputs, to the electrostatic signal line S, the drain voltage Vd of the TFT 43 showing the presence/absence of the touch.

As stated above, the control signal line N1 is inputted not only into the pixel circuits 10r, 10g, 10b but also into the touch detection circuit 30, which is one of characteristic features of the present embodiment.

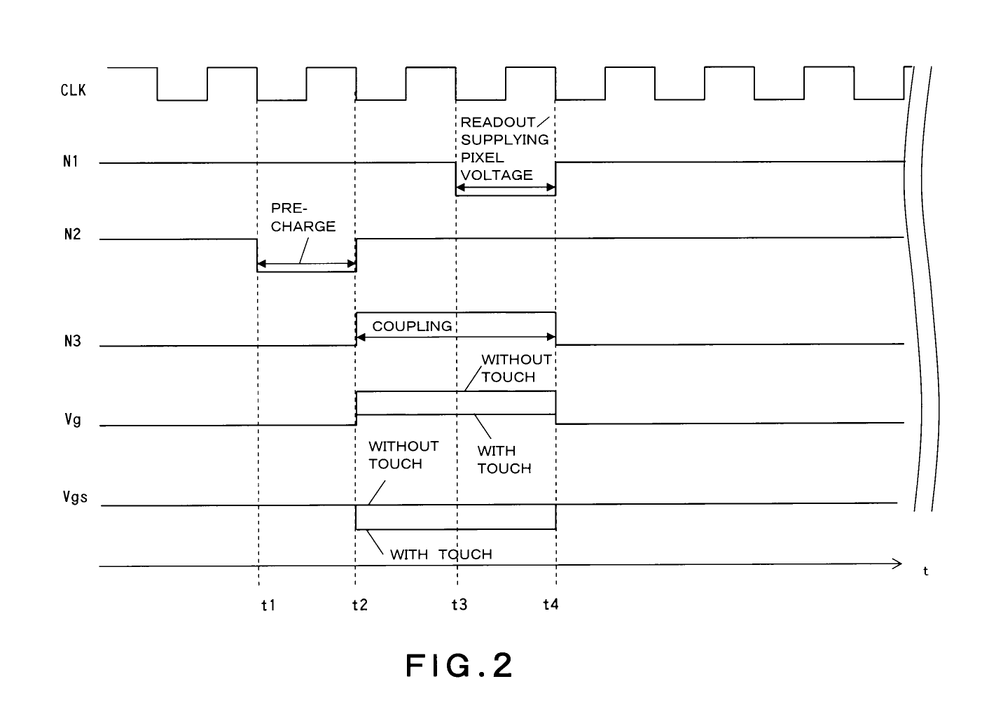

FIG. 2 is a timing chart showing an example of the operation of the pixel 100.

Firstly, when the control signal N2 is set low at time t1, the TFT 42 is turned on. Accordingly, the capacitor Cs and the gate of the TFT 43 are pre-charged at the power supply voltage VSS. Next, when the control signal N2 is set high at time t2, the TFT 42 is turned off and the gate of the TFT 43 becomes a floating state. Further, the control signal N3 is set high at time t2. Then, when the control signal N1 is set low at time t3, the TFT 41 is turned on. Accordingly, the drain voltage Vd of the TFT 43 indicative of the presence/absence of the touch is read out through the electrostatic signal line S.

During the period from time t2 to t4, the control signal N3 operates as a coupling detecting signal for detecting the presence/absence of the touch of the dielectric onto the surface of the organic EL display device.

Firstly, an explanation will be made on a case where there is no touch of the dielectric. When the control signal N3 changes from low to high at time t2, the voltage between the electrodes of the capacitor Cs does not change, which is because the gate of the TFT 43 is in a floating state. Here, the gate of the TFT 43 and the source thereof are connected in parallel with the electrodes of the capacitor Cs, and thus a voltage Vgs between the gate of the TFT 43 and the source thereof does not change around time t2.

On the other hand, when a dielectric such as a finger touches the surface of the organic EL display device, coupling is generated between the finger and the capacitor Cs. That is, series connection between the capacitor Cs and the finger is formed between the control signal line N3 and the ground. Accordingly, when the control signal N3 changes from low to high at time t2, the voltage corresponding to high is shared between the capacitor Cs and the finger. Therefore, only voltage corresponding to the capacitance ratio of the finger to the capacitor Cs is generated between the electrodes of the capacitor Cs. As a result, a gate voltage Vg of the TFT 43 becomes smaller compared to the case where touch of the finger is not detected, and at time t2, the gate-source voltage Vgs of the TFT 43 becomes smaller at time t2.

The gate-source voltage Vgs of the TFT 43 depends on the presence/absence of the touch, and thus the drain voltage Vd of the TFT 43 depends on the presence/absence of the touch. The drain voltage Vd when touch is detected differs from that when touch is not detected, depending on the capacitance etc. of the dielectric whose touch is detected. Therefore, the drain voltage Vd is an analog voltage which is not necessarily limited to high or low. The readout analog voltage is inputted into a determination circuit (not shown) arranged separately from the pixel 100 to determine the presence/absence of the touch of the dielectric by comparing the readout analog voltage with a predetermined threshold value.

On the other hand, during the period from time t3 to t4, the control signal N1 is set low, and thus the TFT 21r in the R pixel circuit 10r is also turned on. Accordingly, the pixel voltage R is supplied to the pixel capacitor Cr and the gate of the TFT 22r. Then, the TFT 22r supplies the drive current depending on the pixel voltage R to the light-emitting element 23r, and the light-emitting element 23r emits the red light having brightness depending on the drive current. Although the control signal N1 is set high and the TFT 21r is turned off at time t4, the pixel capacitor Cr holds the pixel voltage R. Therefore, the light-emitting element 23r continuously emits the light having the same brightness until the pixel voltage R for the next frame is supplied. The light-emitting element 23g in the G pixel circuit 10g and the light-emitting element 23b in the B pixel circuit 10b emit light similarly.

As stated above, the control signal line N1 is shared among the pixel circuits 10r, 10g, 10b and the touch detection circuit 30. In synchronization with the control signal N1, the drain voltage Vd of the TFT 43 indicative of the presence/absence of the touch of the dielectric is read out while the pixel voltages R, G, B are simultaneously supplied. Accordingly, signal lines for controlling the pixel circuits 10r, 10g, 10b and a signal line for controlling the touch detection circuit 30 can be incorporated into one control signal line N1, thereby suppressing the increase in the number of signal lines.

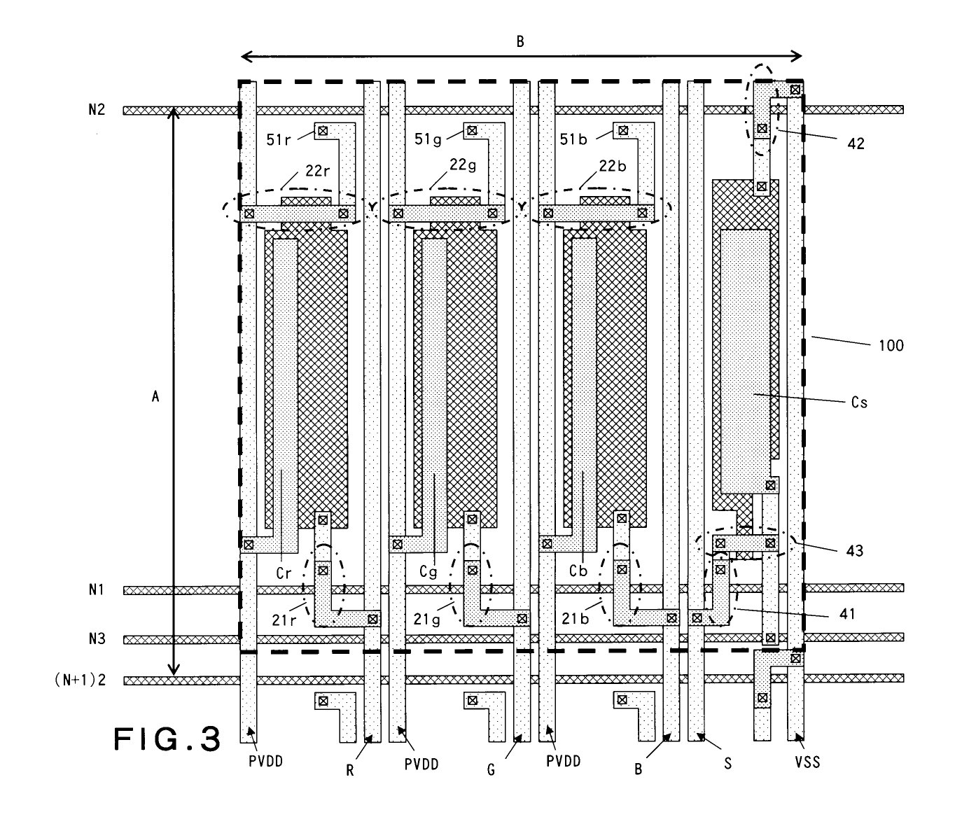

FIG. 3 is a diagram showing an example of a layout pattern of the pixel 100 of FIG. 1. FIG. 3 shows a view from the substrate side, namely, from the bottom. In FIG. 3, the pixel circuits 10r, 10g, 10b and the touch detection circuit 30 are arranged in the horizontal direction. The light-emitting elements 23r, 23g, 23b are not shown in FIG. 3 since those are formed on the TFTs and capacitors. The light-emitting elements 23r, 23g, 23b are connected between contact holes 51r, 51g, 51b in each of the pixel circuits and the power source line PVSS (not shown).

The layout pattern of FIG. 3 is characterized in that the control signal lines N1 to N3 are arranged in parallel in the horizontal direction (first direction), and the power source line PVDD, a ground line VSS of the touch detection circuit, the pixel signal lines R, G, B, and the electrostatic signal line S are arranged in parallel in the vertical direction (second direction). Accordingly, it is possible to form simple wirings in the pixel 100 without complicating the wiring in the pixel 100. These lines are not arranged completely in parallel in some parts due to vias etc. However, it is possible to consider that parallel arrangement is achieved when most of the wires in the pixel 100 are arranged in parallel.

Further, as shown in FIG. 3, large areas are occupied by the pixel capacitors Cr, Cg, Cb and the touch detection capacitor Cs. Therefore, when the pixel circuits 10r, 10g, 10b and the touch detection circuit 30 are arranged in the horizontal direction, it is preferable that these capacitors are formed so that the vertical lengths thereof are longer than horizontal length. As a result, the vertical length of the pixel 100 becomes longer than the horizontal length thereof. More specifically, a distance “A” from the control signal line N2 connected to the pixel 100 in the N-th line to a control signal line (N+1)2 connected to the pixel 100 in the (N+1)-th line is longer than a distance “B” from the power source line PVDD in the R pixel circuit 10r to the power source line VSS in the touch detection circuit 30.

The layout pattern of FIG. 3 is only an example, and the manner for arranging and connecting the elements, the shapes of the elements, etc. are not limited to FIG. 3. For example, the power source line PVDD, the ground line VSS, the pixel signal lines R, G, B, and the electrostatic signal line S formed in the vertical direction may be properly rearranged. In this case also, the distance “A” is longer than the distance between: the wire formed farthest from the touch detection circuit 30 among the wires vertically formed in the pixel circuit; and the wire formed farthest from the pixel circuit among the wires vertically formed in the touch detection circuit 30. Note that, the wire means to any one of the power source line PVDD, the ground line VSS, the pixel signal lines R, G, B, and the electrostatic signal line S.

Further, the light-emitting elements 23r, 23g, 23b are not necessarily formed to have the same size. For example, a light-emitting element having shorter lifetime or lower luminous efficiency may be formed larger than the other light-emitting elements.

The elements used in the touch detection circuit 30 are the TFTs and a capacitor, which are the same as the elements used in each of the pixel circuits 10r, 10g, 10b. Therefore, as shown in FIG. 3, both of the pixel circuits 10r, 10g, 10b and the touch detection circuit 30 can be formed on the same substrate without increasing production cost.

As stated above, in the first embodiment, the pixel circuits 10r, 10g, 10b and the touch detection circuit 30 are formed on the same substrate. Since the same elements are used in each of these circuits, a touch detection function can be added to the organic EL display device while suppressing production cost. Further, in synchronization with the control signal N1, the pixel voltage is supplied while the voltage indicative of the presence/absence of the touch is simultaneously read out. Therefore, the increase in the number of signal lines can be suppressed at the minimum level, thereby suppressing the increase in the area of the pixel 100 and the complexity of wiring in the pixel 100.

### Second Embodiment

A second embodiment to be explained below is different from the first embodiment in the internal configuration of the pixel circuit.

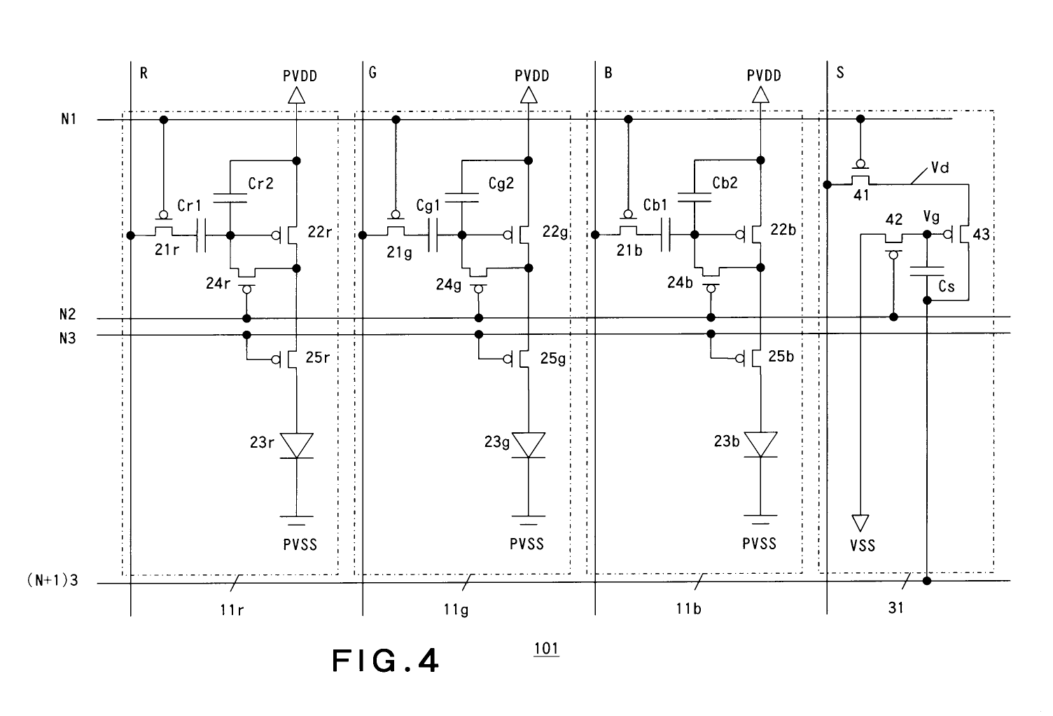

FIG. 4 is a circuit configuration of a pixel 101 in an organic EL display device according to the second embodiment. In FIG. 4, the same symbols are given to the same components as those of FIG. 1, and differences will be mainly explained hereinafter.

An R pixel circuit 11r has a P-type select TFT 21r, a P-type drive TFT 22r, P-type control TFTs 24r and 25r, pixel capacitors Cr1 and Cr2 and an organic EL light-emitting element 23r. The TFTs 22r and 25r and the light-emitting element 23r are connected in series between the power source line PVDD and the power source line PVSS. The gate of the TFT 25r is supplied with the control signal N3. The capacitor Cr2 and the TFT 24r are connected in series between the drain of the TFT 22r and the source thereof. The gate of the TFT 24r is supplied with the control signal N2. The TFT 21r and the capacitor Cr1 are connected in series between the control signal line N1 and the gate of the TFT 22r. The gate of the TFT 21 is supplied with the control signal N1.

Pixel circuits 11g and 11b are similarly configured.

The pixel circuits 11r, 11g, 11b of FIG. 4 are circuits which can suppress the variation in light-emitting brightness of the light-emitting elements 23r, 23g, 23b due to the variation in threshold voltages of the TFTs 22r, 22g, 22b. Further, the touch detection circuit 31 is different from FIG. 1 in that one electrode of the capacitor Cs is not connected to the control signal line N3 but to a control signal line (N+1)3 for the pixel circuits in the next line.

In the present embodiment, the control signals N1 to N3 are inputted not only into the pixel circuits 11r, 11g, 11b but also into the touch detection circuit 31.

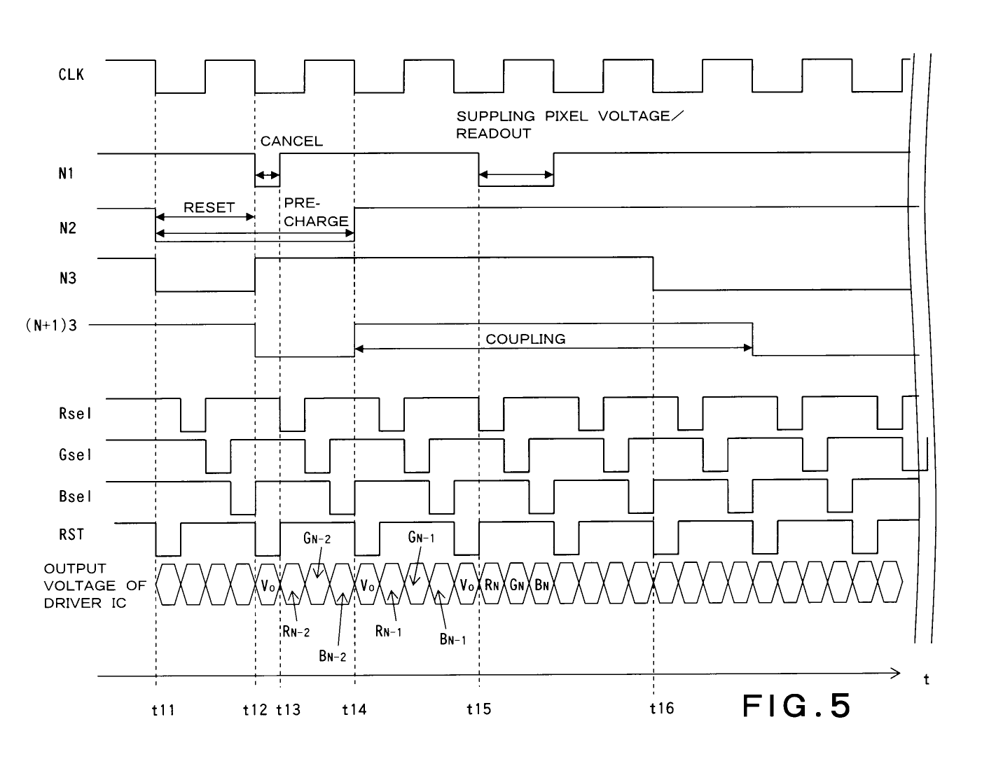

FIG. 5 is a timing chart showing an example of the operation of the pixel 101. In FIG. 5, selection signals Rsel, Gsel, Bsel, a reset signal RST, and a driver IC output voltage signal are signals used by a driver IC (not shown) for setting the pixel voltages R, G, B on pixel signal lines R, G, B, respectively. When the reset signal RST is set low, all of the pixel signal lines R, G, B are set at the output voltage of the driver IC, and the pixel signal lines R, G, B have the same voltage. Further, when the selection signal Rsel is set low, the pixel signal line R is set at the output voltage of the driver IC. A similar operation is performed on the selection signals Gsel and Bsel.

Firstly, the operation of the R pixel circuit 11r will be explained. When the control signals N2 and N3 are set low at time t11, the TFTs 24r and 25r are turned on. Accordingly, the gate voltage Vg of the TFT 22r becomes equal to the drain voltage thereof, and thus the gate voltage Vg is reset. Next, when the control signal N3 is set high at time t12, the TFT 25r is turned off and the gate of the TFT 22r becomes a floating state. At time t12, the control signal N1 is simultaneously set low, and thus the TFT 21r is turned on. At time t12, the reset signal RST is set low, and thus the voltage of the pixel signal line R is a constant voltage Vo.

Because the TFT 25r is turned off at this time, current does not flow between the drain of the TFT 22r and the source thereof. Further, because the TFT 24r is turned on, the gate of the TFT 22r and drain thereof are conducted. When charges accumulated in the capacitor Cr2 are completely discharged in this state, the gate-source voltage Vgs of the TFT 22r becomes equal to a threshold voltage Vth of the TFT 22r. Although there is a possibility that each R pixel circuit 11r has variation in this threshold voltage Vth, the variation is canceled by setting the gate-source voltage Vgs to the threshold voltage Vth peculiar to the TFT 22r.

After that, when the control signal N1 is set low at time t15, the voltage of the pixel signal line R is supplied to the pixel capacitors Cr1 and Cr2 and the gate of the TFT 22r. Because the selection signal Rsel is set low at time t15, the voltage of the pixel signal line R at this time is a voltage R_{N} indicative of the voltage of the pixel in the N-th line. As a result, the gate-source voltage Vgs of the TFT 22r changes from the threshold voltage Vth by a value obtained by dividing the difference between the power supply voltage PVDD and the voltage R_{N} by the pixel capacitors Cr1 and Cr2. The voltage can be expressed by the following equation (1).

Vg=Vth+(R_{N}−PVDD)*Cr1/(Cr1+Cr2) (1)

After that, the pixel capacitors Cr1 and Cr2 continuously hold the gate-source voltage Vgs in the above equation (1) after the control signal N1 is set high and the TFT 21r is turned off.

When the control signal N3 is set low at time t16, the TFT 25r is turned on. Accordingly, current depending on a voltage Vgs−Vth flows between the drain of the TFT 22r and source thereof. According to the above equation (1), the voltage Vgs−Vth does not depend on the threshold voltage Vth. Therefore, even if the threshold voltage Vth varies, the variation in the threshold voltage Vth can be cancelled by driving in accordance with the timings of FIG. 5, and current depending on the pixel voltage R_{N} can be supplied to the light-emitting element 23r.

A control signal (N+1)3 is inputted into one end of the capacitor Cs in the touch detection circuit 31. This the control signal (N+1)3 is also inputted into the pixel circuits 11r, 11g, 11b in the (N+1)-th line, and its operation is delayed from the control signal N3 by “1” CLK. Therefore, the control signal (N+1)3 corresponds to the control signal N3 of FIG. 2, and the touch detection circuit 31 of FIG. 4 operates similarly to the touch detection circuit 30 of FIG. 1.

Firstly, at time t11, pre-charge is performed by the control signal N2. Next, at time t14, the control signal (N+1)3 is set high to operate as a coupling detecting signal. Then, at time t15, the drain voltage Vd of the TFT 43 indicative of the presence/absence of the touch is read out by the control signal N1.

In the case of the pixel 101 of FIG. 4, the control signals N1 and (N+1)3 for controlling the pixel circuits 11r, 11g, 11b are also used to control the touch detection circuit 31. Therefore, even when the touch detection circuit 31 is provided in addition to the pixel circuits 11r, 11g, 11b, it is unnecessary to add a new control signal.

In the present embodiment, the presence/absence of the touch to the last line cannot be detected by the touch detection circuit 31. However, it does not matter for practical use.

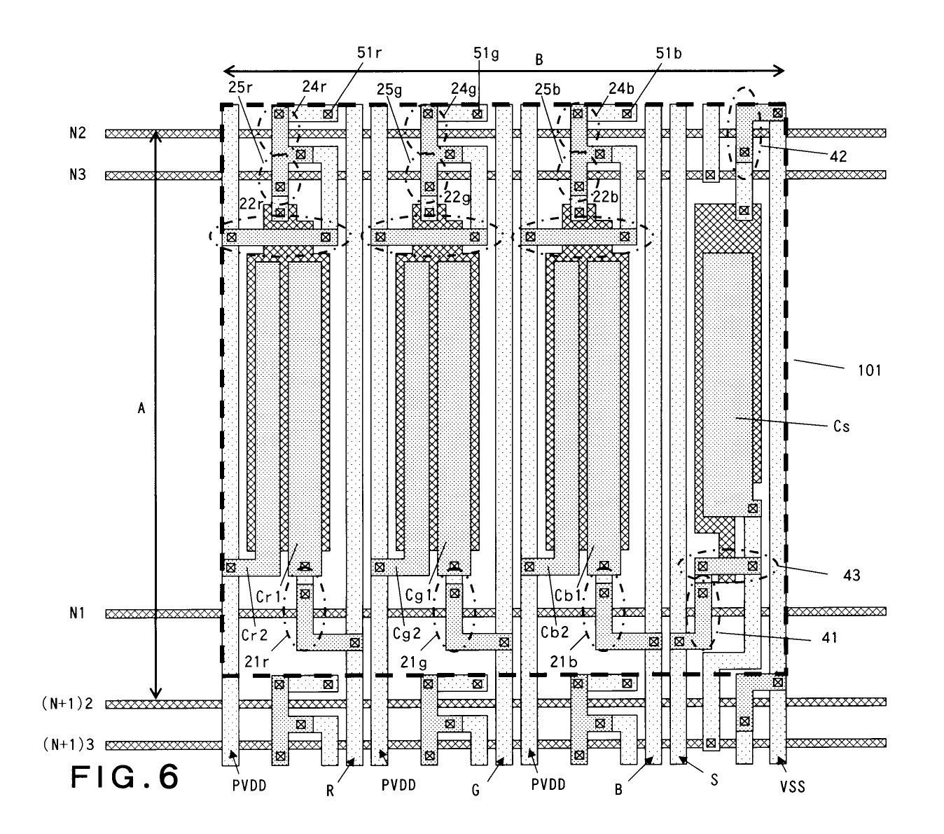

FIG. 6 is a diagram showing an example of the layout pattern of the pixel 101 of FIG. 4. Although the circuit configurations of the pixel circuits 11r, 11g, 11b of FIG. 4 are more complicated than those of the pixel circuits 10r, 10g, 10b of FIG. 1, the pixel circuits 11r, 11g, 11b and the touch detection circuit 31 can be formed on the same substrate as shown in FIG. 6.

Similarly to the layout pattern of FIG. 3, in the layout pattern of FIG. 6, the control signal lines N1 to N3 are arranged in parallel in the horizontal direction, while the power source line PVDD, VSS, the pixel signal lines R, G, B, and the electrostatic signal line S are arranged in parallel in the vertical direction. Further, the distance “A” of the pixel 101 in the vertical direction is longer than the distance “B” in the horizontal direction.

As stated above, in the second embodiment, even when the threshold voltage Vth varies, the light-emitting element 23r can emit light without being influenced by the variation owing to the reset and cancel operation. Accordingly, a touch detection function can be added to an organic EL display device having higher image quality. Further, the control signals N1 to N3 for controlling the pixel circuits 11r, 11g, 11b are used to control the touch detection circuit 31. Therefore, it is unnecessary to add a new signal line for the touch detection circuit 31.

### Third Embodiment

The above mentioned first and second embodiments share control signal lines. On the other hand, in a third embodiment to be explained below, the pixel signal line B and the electrostatic signal line S are further shared.

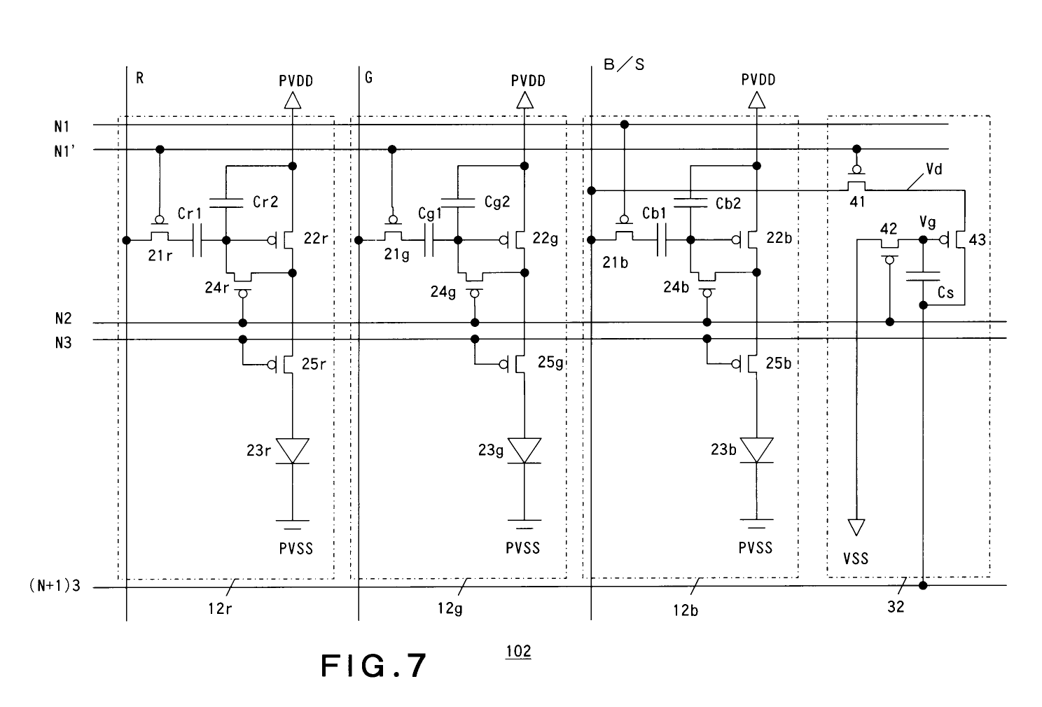

FIG. 7 is a circuit configuration of a pixel 102 in an organic EL display device according to the third embodiment. In FIG. 7, the same symbols are given to the same components as those of FIG. 4, and differences will be mainly explained hereinafter.

The circuit configurations of pixel circuits 12r and 12g of FIG. 7 are similar to FIG. 4, while the TFTs 21r and 21g are supplied with not a control signal N1 (first control signal) but a control signal (second control signal) N1′ through a control signal line (second control signal line) N1′.

A signal line B/S is shared among a B pixel circuit 12b and a touch detection circuit 32. That is, the signal line B/S is connected to both of the TFT 21b in the B pixel circuit 12b and the TFT 41 in the touch detection circuit 32. Further, the gate of the TFT 21b is supplied with the control signal N1, and the gate of the TFT 41 supplied with the control signal N1′.

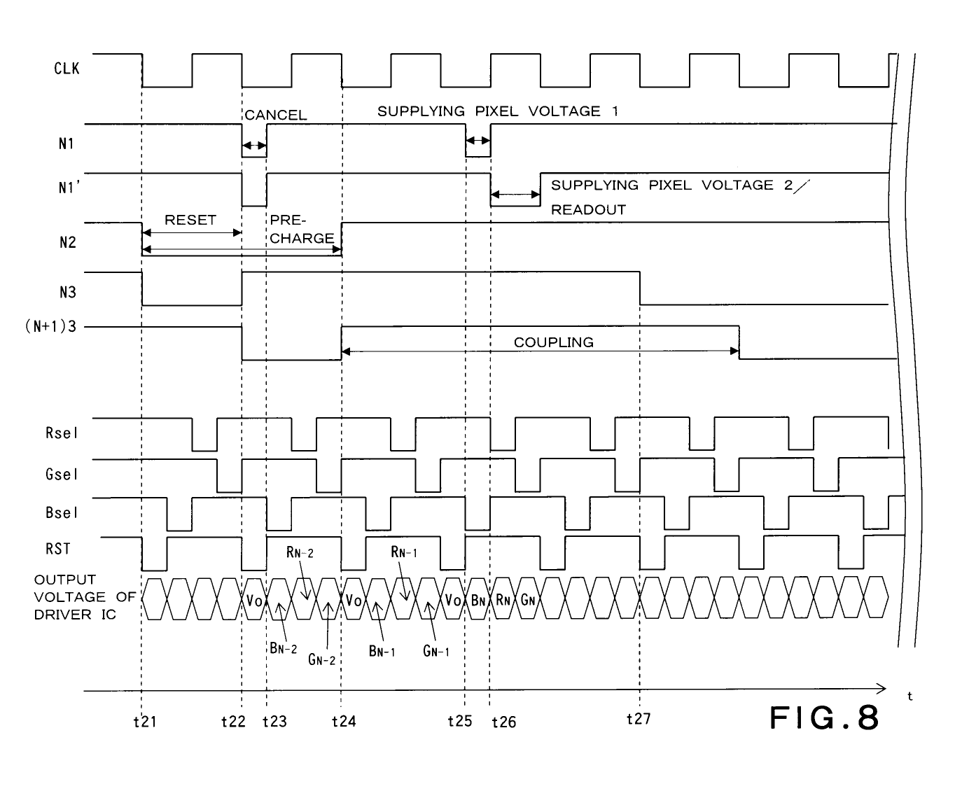

FIG. 8 is a timing chart showing an example of the operation of the pixel 102. FIG. 8 is different from FIG. 5 mainly in that the control signal N1′ is added and that an outputting order of the pixel voltages from the driver IC.

The operation in the period from time t21 to t25 is similarly to the circuit of FIG. 4, and the variation in the threshold voltages Vth of the TFTs 22r, 22g, 22b in the pixel circuits 12r, 12g, 12b respectively is cancelled.

When the control signal N1 is set low at time t25, the TFT 21b in the B pixel circuit 12b is turned on. At this time, a pixel voltage B_{N} is outputted from the driver IC on the signal line B/S, and the pixel voltage B_{N} is supplied to the B pixel circuit 12b through the signal line B/S. Then, when the control signal N1 is set high at time t26, the TFT 21b is turned off.

Further, when the control signal N1′ is set low at time t26, the TFTs 21r and 21g in the pixel circuits 12r and 12g are turned on. Accordingly, the pixel voltages R_{N} and G_{N} are supplied to the pixel circuits 12r and 12b through the pixel signal lines R and G, respectively. At the same time, the TFT 41 in the touch detection circuit 32 is turned on, and the drain voltage Vd of the TFT 43 indicative of the presence/absence of the touch is read out through the signal line B/S.

The subsequent operation is similar to FIG. 5.

As stated above, pixel voltage is supplied to the B pixel circuit 12b in the period from time t25 to t26, and after that, the voltage indicative of the presence/absence of the touch is read out in the period from time t26 to t27. Because the timing for supplying pixel voltage is different from that for reading out the voltage indicative of the presence/absence of the touch, it is possible to incorporate the signal line for controlling the B pixel circuit 12b and the signal line for reading the voltage indicative of the presence/absence of the touch from the touch detection circuit 32 into one signal line B/S.

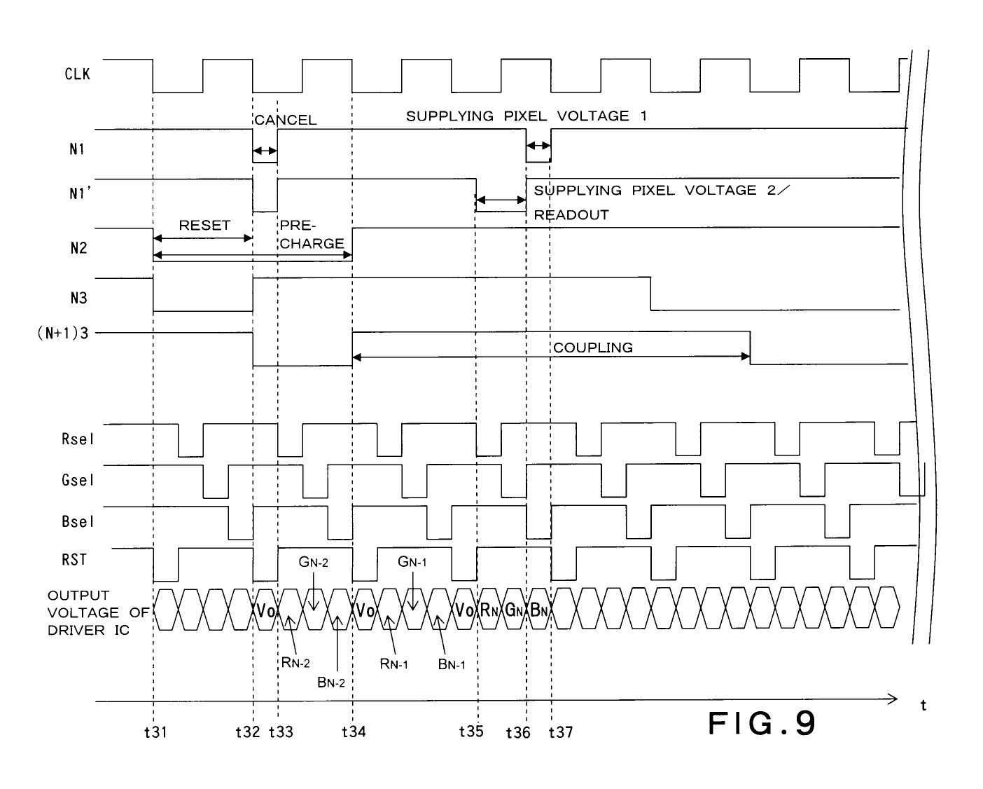

FIG. 9 is a timing chart showing another example of the operation of the pixel 102. The operation timings in the period from time t31 to t35 are similar to FIG. 8. When the control signal N1′ is set low at time t35, the TFTs 21r and 21g in the pixel circuits 12r and 12g respectively are turned on. Accordingly, the pixel voltages R_{N} and G_{N} are supplied to the pixel circuits 12r and 12g through the pixel signal lines R and G, respectively. At the same time, the TFT 41 in the touch detection circuit 32 is turned on, and the voltage indicative of the presence/absence of the touch is read out through the signal line B/S.

Further, when the control signal N1 is set low at time t36, the TFT 21b in the B pixel circuit 12b is turned on. Accordingly, the pixel voltage B is supplied to the B pixel circuit 12b through the signal line B/S. The subsequent operation timings are similar to FIG. 8.

FIG. 9 is different from FIG. 8 in that the voltage Vd indicative of the presence/absence of the touch is read out firstly in the period from time t35 to t36, and the pixel voltage B_{N} is subsequently supplied to the B pixel circuit 12b in the period from time t36 to t37. In other words, time since the voltage indicative of the presence/absence of the touch is read out until the pixel voltage B is supplied is shorter than time since the pixel voltage B is supplied to the B pixel circuit 12b until the voltage indicative of the presence/absence of the touch is read out again.

As shown in FIG. 8, when the pixel voltage B_{N} is supplied in advance, there is a likelihood that the pixel voltage B_{N} already supplied to the B pixel circuit 12b may vary due to the read-out operation of the voltage indicative of the presence/absence of the touch and the variation may be observed. Particularly, when the light-emitting element 23b having shorter lifetime is formed larger than the other light-emitting elements 23r and 23g, the pixel voltage B_{N} may be easily influenced by the read-out operation because the light-emitting element 23b has a large capacitor.

Therefore, as shown in FIG. 9, the voltage indicative of the presence/absence of the touch is read out in advance, and the pixel voltage B_{N} is subsequently supplied, by which the influence of read-out operation can be suppressed, thereby improving the image quality.

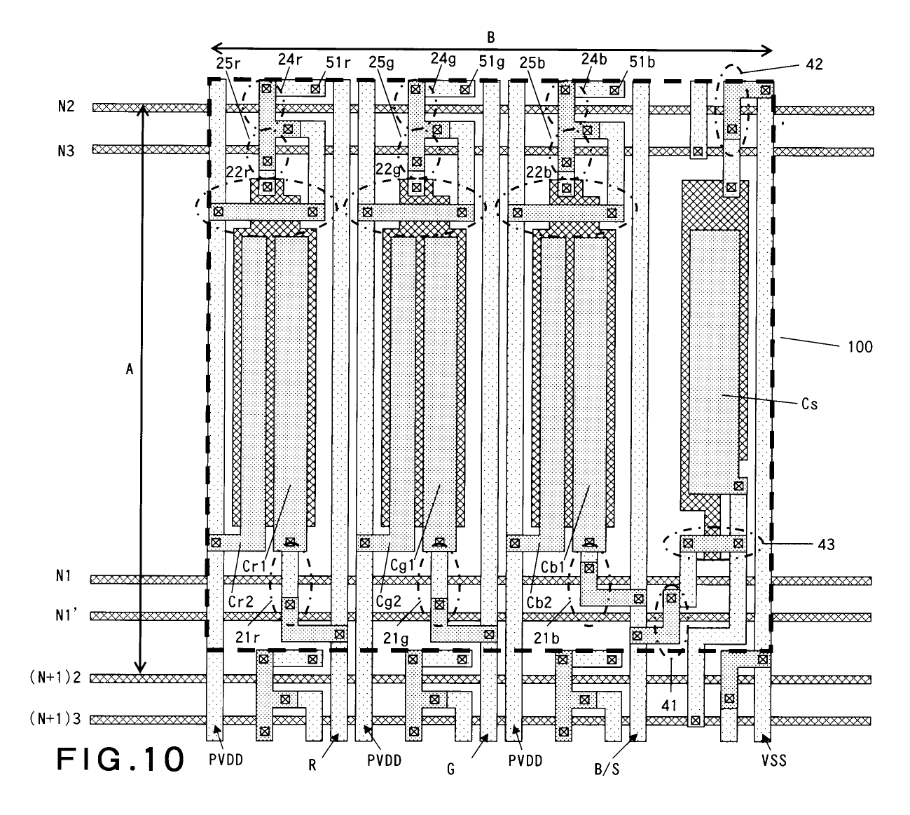

FIG. 10 is a diagram showing an example of the layout pattern of the pixel 102 of FIG. 7. Similarly to the layout pattern of FIG. 6, in the layout pattern of FIG. 10, the control signal lines N1, N1′, N2, while N3 are arranged in parallel to each other in the horizontal direction, and the power source lines PVDD and VSS, the pixel signal lines R and G, and the signal line B/S are arranged in parallel to each other in the vertical direction. Further, the distance “A” of the pixel 102 in the vertical direction is longer than the distance “B” in the horizontal direction.

As stated above, also when the light-emitting element 23b is formed larger than the light-emitting elements 23r and 23g, the layout is preferable where the top of the capacitor Cs having capacitance detected through the signal line B/S is not covered in order not to reduce the sensitivity for detecting touch.

As stated above, in the third embodiment, the pixel circuits 12r, 12g, 12b and the touch detection circuit 32 are formed on the same substrate, and the pixel signal line B and the capacitance line S are shared in addition to the control signal lines N1′, N2 and (N+1)3. Therefore, the number of signal lines can be further reduced. Further, image quality can be improved by supplying the pixel voltage B_{N} after reading out the voltage indicative of the presence/absence of the touch.

### Fourth Embodiment

A fourth embodiment is a modification example of the third embodiment.

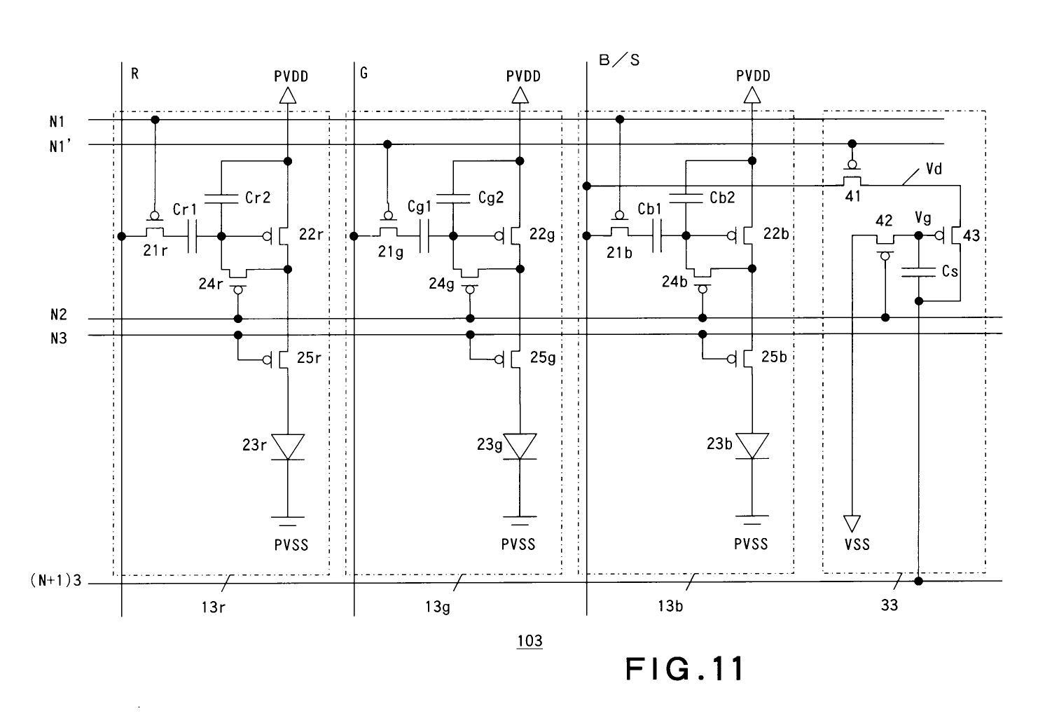

FIG. 11 is a circuit configuration of a pixel 103 in an organic EL display device according to the fourth embodiment. FIG. 11 is different from FIG. 7 in that the gate of the TFT 21r in the R pixel circuit 11r is supplied with the control signal N1, not with the control signal N1′.

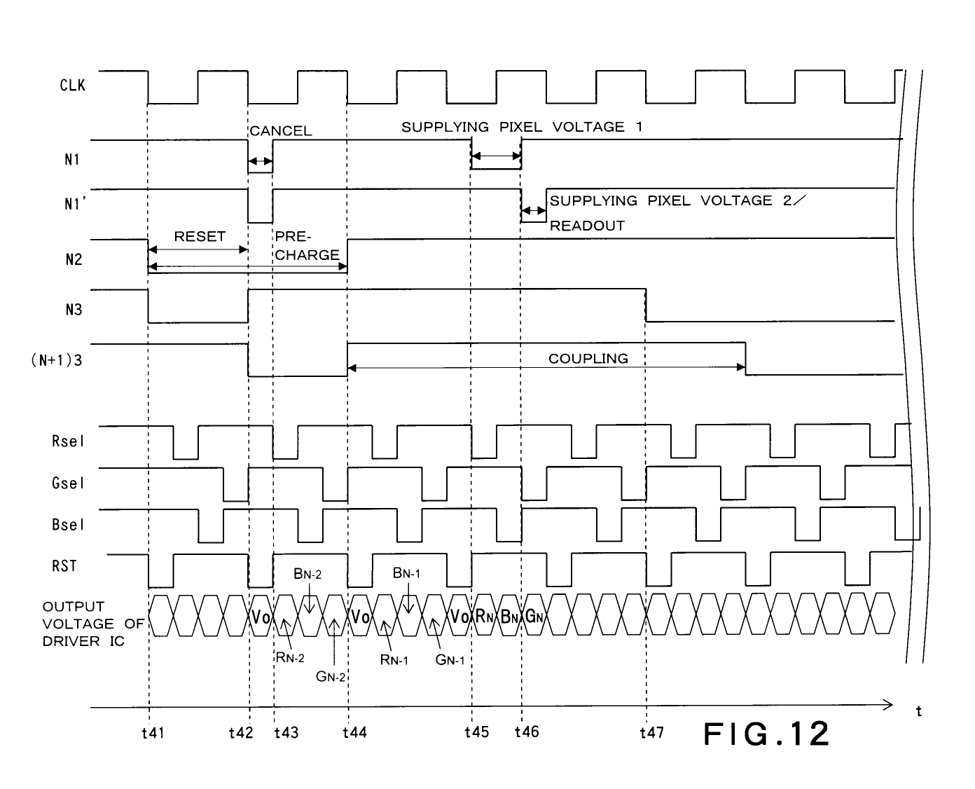

FIG. 12 is a timing chart showing an example of the operation of the pixel 103. Hereinafter, differences from FIG. 8 will be mainly explained. The operation timings in the period from time t41 to t45 are similar to FIG. 8. When the control signal N1 is set low at time t45, the TFTs 21r and 21b in pixel circuits 13r and 13b respectively are turned on. Accordingly, the pixel voltages R_{N} and B_{N} are supplied to the pixel circuits 13r 13b through the pixel signal lines R and B/S, respectively.

Then, when the control signal N1′ is set low at time t46, the TFT 21g in a G pixel circuit 13g is turned on. Accordingly, the pixel voltage G_{N} is supplied to the G pixel circuit 13g through the pixel signal line G. At the same time, the TFT 41 in a touch detection circuit 33 is turned on, and the drain voltage Vd of the TFT 43 indicative of the presence/absence of the touch is read out through the signal line B/S.

The subsequent operation timings are similar to FIG. 8.

On the left side of FIG. 11, an adjacent pixel 103 is arranged (not shown). The R pixel circuit 13r of FIG. 11 is arranged close to the touch detection circuit 33 in the adjacent pixel 103. In a control with the timings of FIG. 12, the pixel voltage R_{N} is supplied in the period from time t45 to t46, and the voltage Vd indicative of the presence/absence of the touch is read out at time t46. That is, reading out the voltage Vd is not performed simultaneously with supplying the pixel voltage R_{N} to the adjacent R pixel circuit 13r. Accordingly, it is possible to suppress the influence of reading out the voltage Vd on the pixel voltage R_{N} supplied to the R pixel circuit 13r.

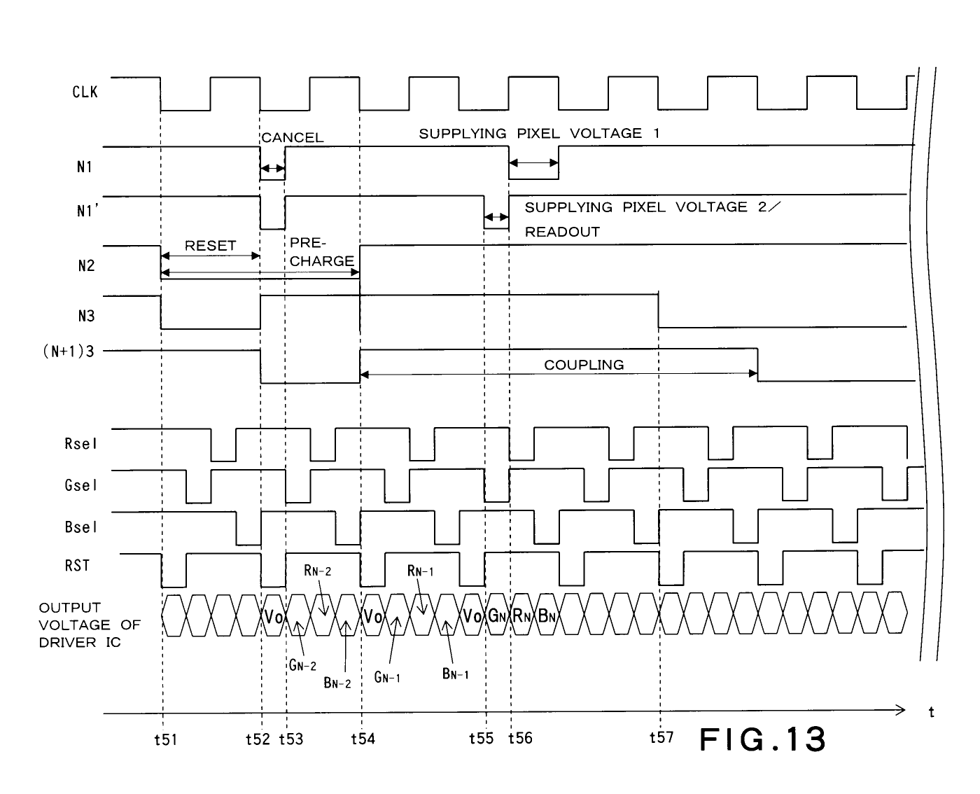

FIG. 13 is a timing chart showing another example of the operation of the pixel 103. In FIG. 13, at time t55, supplying to the G pixel circuit 13g and reading-out of the voltage Vd are performed. Then, at time t56, pixel voltages are supplied to the pixel circuits 13r and 13b. Similarly to the operation timings of FIG. 9, by supplying the pixel voltage B_{N} after reading out the voltage Vd, it is possible to suppress the variation in the pixel voltage B_{N} due to reading out the voltage Vd.

As stated above, in the fourth embodiment, the timing for supplying pixel voltage to the R pixel circuit 13r adjacent to the touch detection circuit 33 is different from that for reading out the voltage Vd indicative of the presence/absence of the touch. Therefore, the pixel voltage R supplied to the R pixel circuit 13r is not influenced by the operation of reading out the voltage Vd, thereby further improving the image quality.

### Fifth Embodiment

In a fifth embodiment, an example is shown where N-type TFTs are used in the pixel circuit and the touch detection circuit.

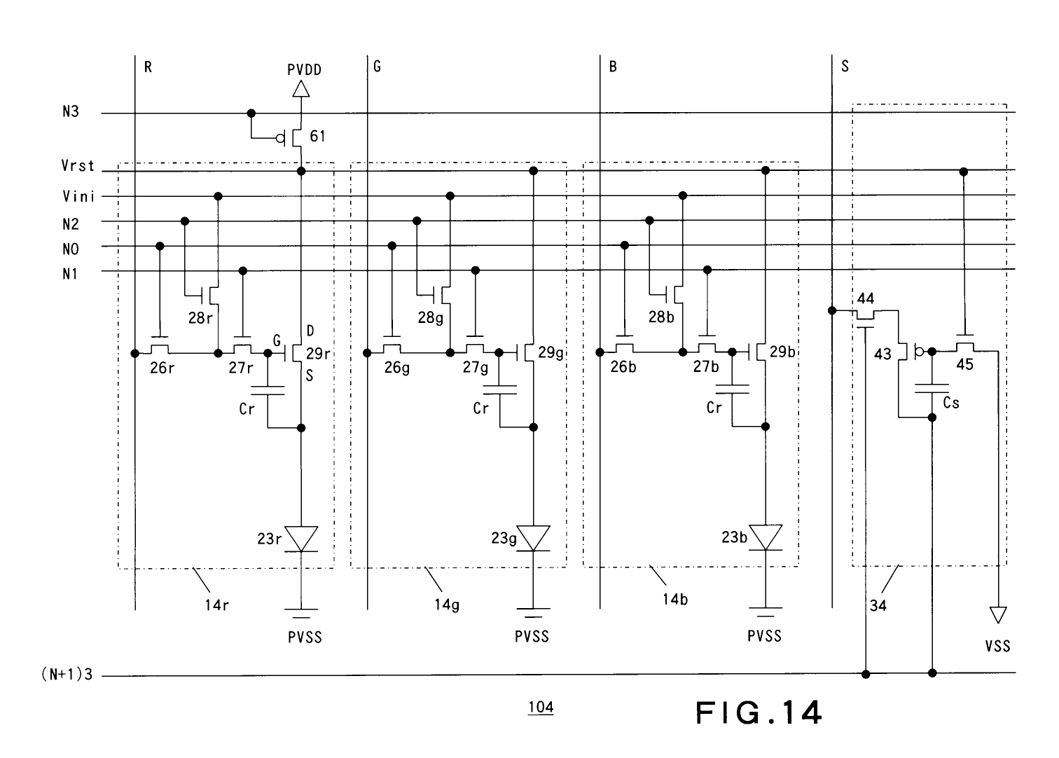

FIG. 14 is a circuit configuration of a pixel 104 in an organic EL display device according to the fifth embodiment.

An R pixel circuit 14r has an organic EL light-emitting element 23r, N-type select TFTs 26r and 27r, an N-type control TFT 28r, and an N-type drive TFT 29r. The TFT 29r and the light-emitting element 23r are connected in series between the power source line PVSS and the drain of a P-type control TFT 61 arranged outside the R pixel circuit 14r. The TFTs 26r and 27r are connected in series between the pixel signal line R and the gate of the TFT 29r. The control TFT 28r is connected between an initial voltage line Vini and the connection node of the TFTs 26r and 27r. The pixel capacitor Cr is connected between the gate of the TFT 29r and the source thereof. The gates of the TFTs 26r to 28r are supplied with control signals N0 to N2, respectively. Pixel circuits 14g and 14b are similarly configured. The source of the TFT 61 is supplied with the power supply voltage PVDD, and the gate thereof is supplied with the control signal N3.

In the present embodiment, the power supply voltage PVDD is 10V, for example, and the power supply voltage PVSS is 1.5V, for example.

A touch detection circuit 34 has a P-type capacitance detection TFT 43, an N-type select TFT 44, an N-type pre-charge TFT 45 and the touch detection capacitor Cs. The TFTs 43 and 44 are connected in series between the electrostatic signal line S and the control signal line (N+1)3. The gate of the TFT 44 is supplied with the control signal (N+1)3. The capacitor Cs is connected between the gate of the TFT 43 and the source thereof. The TFT 45 is connected between the gate of the TFT 43 and the power source line VSS. The gate of the TFT 45 is supplied with the control signal N3.

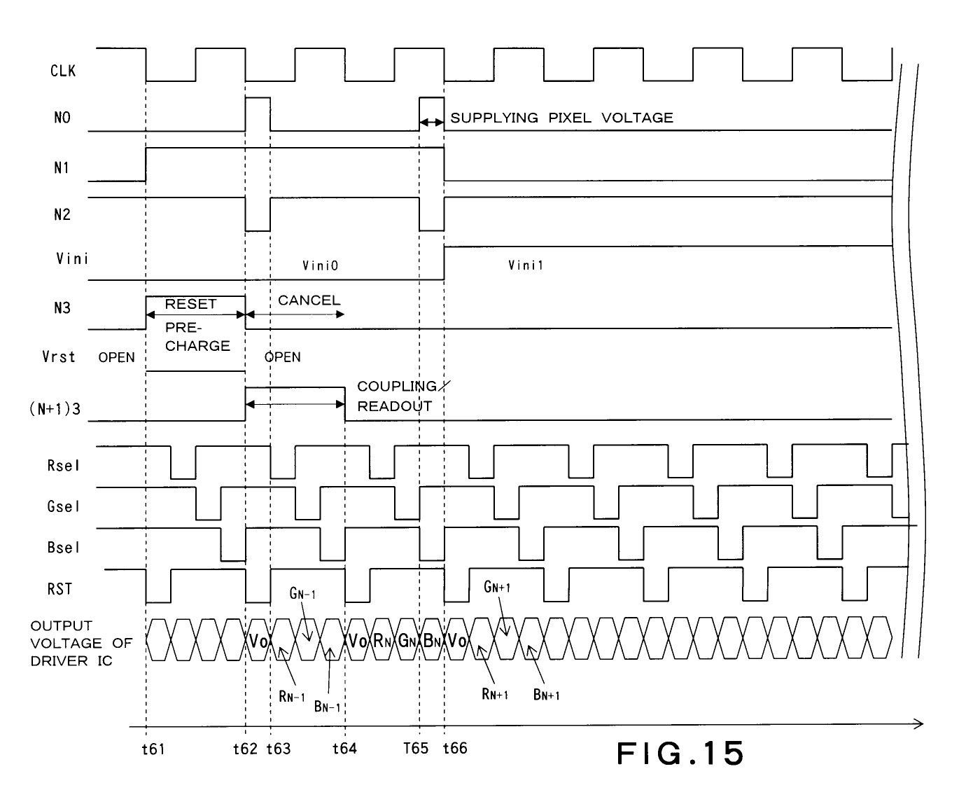

FIG. 15 is a timing chart showing an example of the operation of the pixel 104.

At time t61, the control signal N0 is set low, and the control signals N1, N2, and N3 are set high. Accordingly, the TFTs 27r and 28r are turned on, and thus the gate of the TFT 29r is set at an initialization voltage Vini0. Further, because the TFT 61 is turned off, the drain of the TFT 29r is supplied with a reset voltage Vrst. By such a manner, the pixel voltage value of the previous frame is reset, and the gate-source voltage Vgs of the TFT 29r is set to a constant value. Note that, the initialization voltage Vini0 and the reset voltage Vrst are set so that the TFT 29r is not turned on to prevent the light-emitting element 23r from emitting light in the reset operation. For example, when the threshold voltage Vth of the TFT 29r is 1.5V, the initialization voltage Vini0 is set to 1V and the reset voltage Vrst is set to −2V.

At time t62, the control signals N0 and N1 are set high, and the control signals N2 and N3 are set low. Accordingly, the TFTs 26r and 27r are turned on. At this time, because the driver IC outputs the constant voltage Vo, the gate voltage of the TFT 29r is set to this constant voltage Vo by the pixel signal line R through the TFTs 26r and 27r. Also in this case, the constant voltage Vo is set to be lower than the threshold voltage Vth of the TFT 29r so as not to turn on the TFT 29r. The constant voltage Vo is set to 1V, for example.

On the other hand, when the TFT 61 is turned on and the reset voltage Vrst is opened at time t62, the drain of the TFT 29r is supplied with the power supply voltage PVDD.

At time t63, the control signal N0 is set low, and the control signal N2 is set high. Accordingly, the TFT 26r is turned off, and the TFT 28r is turned on instead. Therefore, the gate of the TFT 29r is set at the initialization voltage Vini0 again. At this time, because the source of the TFT 29r is effectively in a floating state, current does not flow between the drain of the TFT 29r and the source thereof. Therefore, the gate-source voltage Vgs of the TFT 29r becomes equal to the threshold voltage Vth of the TFT 29r. Accordingly, the source voltage of the TFT 29r becomes Vini0−Vth.

Since the reset operation is performed at time t61, the gate-source voltage Vgs of the TFT 29r can be surely set equal to the threshold voltage Vth regardless of the pixel voltage of the previous frame.

At time t65, the control signals N0 and N1 are set high. Accordingly, the TFTs 26r and 27r are turned on, and the gate of the TFT 29r is set at the voltage of the pixel signal line R. The driver IC has outputted the voltage R_{N} indicative of the pixel voltage of the N-th line before time t65, and this voltage is hold in the pixel signal line R. Accordingly, at time t65, the gate voltage of the TFT 29r changes from the initialization voltage Vini0 to the voltage R_{N}. As a result, the gate-source voltage Vgs of the TFT 29r changes from the threshold voltage Vth to the voltage expressed by the following equation (2).

Vgs=Vth+(R_{N}−Vini0)*Cr/(Cr+Cr_{—}EL) (2)

Here, the Cr_EL represents the capacitance of the light-emitting element 23r.

Accordingly, current depending on the voltage Vgs−Vth flows between the drain of the TFT 29r and the source thereof. According to the above equation (2), the voltage Vgs−Vth does not depend on the threshold voltage Vth. Therefore, even if the threshold voltage Vth varies, the variation can be cancelled and current depending on the pixel voltage R_{N} can be supplied to the light-emitting element 23r by driving it in accordance with the timings shown in FIG. 15.

When supplying the voltage R_{N} is completed at time t66, the control signals N0 and N1 are set low. Accordingly, the TFTs 26r and 27r are turned off, and the gate voltage of the TFT 29r is fixed. Further, at time t66, the control signal N2 is set high. Accordingly, the TFT 28r is turned on, and thus the connection node of the TFTs 26r and 27r is set at an initialization voltage Vini1. This initialization voltage Vini1 is 5.5V, for example, which is higher than Vini0. As stated above, the voltage of the connection node of the TFTs 26r and 27r is set high, which reduces the influence of the voltage change of the pixel signal line R on the TFT 29r, and the potential of the TFT 29r is fixed. Therefore, the light-emitting element 23r emits light stably.

On the other hand, the touch detection circuit 34 operates as follows.

When the control signal N3 is set high at time t61, the TFT 45 is turned on. Accordingly, the capacitor Cs and the gate of the TFT 43 are pre-charged at the power supply voltage VSS. Next, when the control signal N3 is set low at time t62, the TFT 45 is turned off and the gate of the TFT 43 becomes a floating state.

Further, at time t62, the control signal (N+1)3 is set high. In the period from time t62 to t64, the control signal (N+1)3 acts as a coupling detecting signal for detecting the presence/absence of the touch of the dielectric onto the surface of the organic EL display device. That is, the gate-source voltage Vgs of the TFT 43 depends on the presence/absence of the touch of the dielectric.

Further, because, the control signal (N+1)3 is set high at time t62, the TFT 44 is turned on. Accordingly, drain voltage depending on the gate-source voltage Vgs of the TFT 43 indicative of the presence/absence of the touch is read out and outputted to the electrostatic signal line S. The presence/absence of the touch is determined based on this voltage.

As stated above, in the fifth embodiment, by using the initialization voltages Vini0 and Vini1 and the reset voltage Vrst, it is possible to suppress the variation in the threshold voltage Vth of the TFTs 29r, 29g, 29b and the influence of the change of the voltage of the pixel signal lines R, G, B. Further, the touch detection circuit 34 is controlled by the control signals N3 and (N+1)3 used for controlling the pixel circuits 14r, 14g, 14b. Therefore, it is unnecessary to add a new signal line for the touch detection circuit 34. Accordingly, a touch detection function can be added to an organic EL display device having higher image quality without increasing cost.

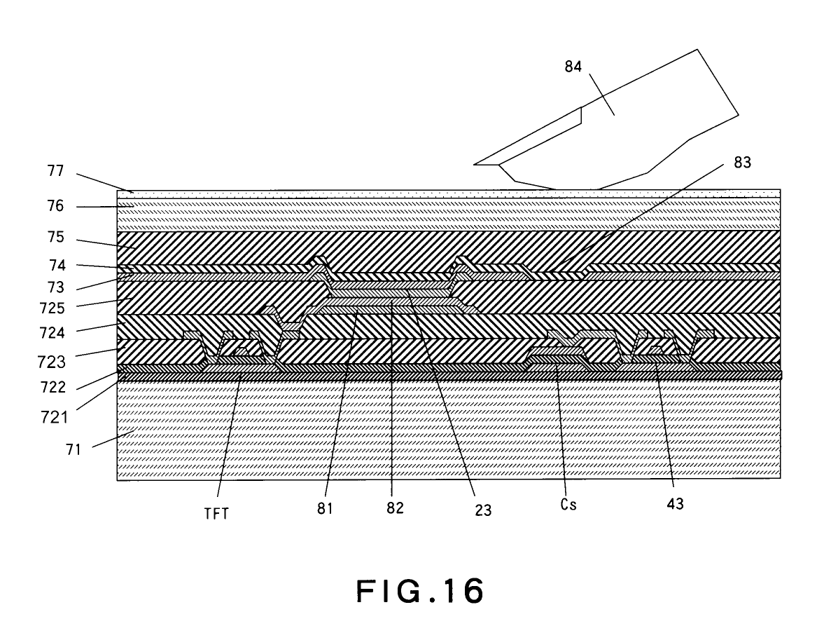

FIG. 16 is a sectional view of the organic EL display device according to each of the above embodiments. FIG. 16 shows a part of the pixel circuit and the touch detection circuit.

An organic EL light-emitting element 23, a touch detection capacitor Cs, TFTs, etc. composing the pixel circuit and the touch detection circuit are formed on a glass substrate 71 and are insulated from each other by insulating layers 721 to 725. A reflective layer 81 and an ITO (Indium Tin Oxide) electrode 82 serving as the anode of a light-emitting element 23 are formed under the organic EL light-emitting element 23. Further, a cathode 73, a sealing film 74 and a filling resin 75 are formed on the organic EL light-emitting element 23, and a sealing glass 76 and a circularly polarizing plate 77 are further arranged on the filling resin 75.

The thickness of each layer is approximately set as follows: 0.1 mm to 0.7 mm for the glass substrate 71; 50 nm to 100 nm for each of the insulating layers 721 to 725; 100 nm to 500 nm for the cathode 73; 1 μm to 10 μm for the sealing film 74; 1 μm to 100 μm for the filling resin 75; 0.1 mm to 0.7 mm for the sealing glass 76; 0.1 mm to 0.2 mm for the circularly polarizing plate 77, for example.

FIG. 16 shows a top emission type organic EL display device in which light from the organic EL light-emitting element 23 is taken out from the top surface. That is, the surface where the circularly polarizing plate 77 is arranged is a display surface, and a surface for detecting touch of a dielectric 84 such as a finger.

The cathode 73 of the light-emitting element 23 is made of a light transmissive material. The cathode 73 is arranged in common among the R, G, B pixel circuits, and is connected to the power source line PVSS (not shown). On the other hand, the ITO electrode 82 serving as the anode of the light-emitting element 23 is connected to the TFT, and is driven by this TFT. The TFT of FIG. 16 corresponds to one of the TFTs 22r, 22g, 22b of FIG. 1, the TFTs 25r, 25g, 25b of FIGS. 4, 7, and 11, and the TFTs 29r, 29g, 29b of FIG. 14.

Arranged above the touch detection capacitor Cs is a cathode opening 83, where the cathode is not formed. Therefore, it is possible to improve sensitivity for detecting touch of the dielectric.

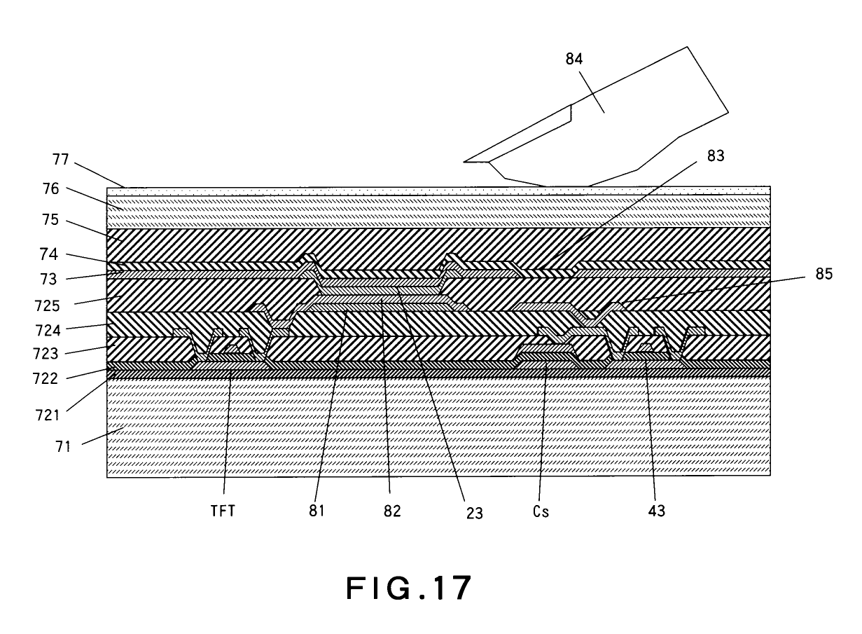

FIG. 17 is a sectional view of an organic EL display device in a modification example. In FIG. 17, the same symbols are given to the same components as those of FIG. 16, and differences will be mainly explained hereinafter.

The organic EL display device of FIG. 17 is different from FIG. 16 in that an electrode 85 is arranged above the touch detection capacitor Cs. The electrode 85, which is made of a material such as ITO, can be formed at the same time when forming the ITO electrode 82 on the reflective layer 81. This electrode 85 is electrically connected to the electrode of the capacitor Cs on the display surface side. The electrode 85 can be formed close to the display surface and occupy a large area. Therefore, capacitance due to the touch of the dielectric 84 can be efficiently generated, thereby improving the sensitivity for detecting touch.

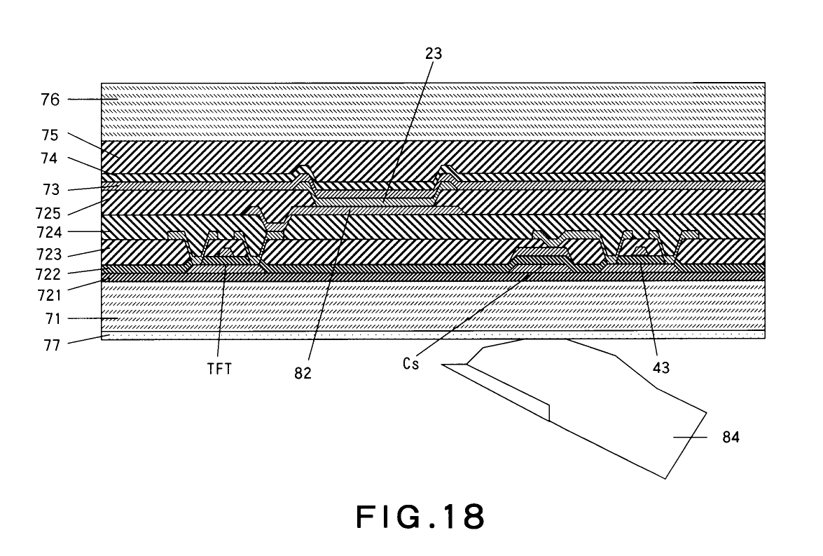

FIG. 18 is a sectional view of an organic EL display device in another modification example. In FIG. 18, the same symbols are given to the same components as those of FIG. 16, and differences will be mainly explained hereinafter.

FIG. 18 shows a bottom emission type organic EL display device in which light from the organic EL light-emitting element 23 is taken out from the bottom surface. In FIG. 18, the reflective layer is not formed under the electrode 82. Further, the circularly polarizing plate 77 is arranged under the glass substrate 71. The circularly polarizing plate 77 serves as the display surface and the surface for detecting touch of the dielectric 84.

As stated above, the light-emitting element 23 and the touch detection capacitor Cs for detecting touch of the dielectric are formed on the same substrate 71, which makes it possible to form an organic EL display device capable of detecting the presence/absence of the touch by a dielectric without using a separate touch panel unit.

The organic EL display devices of FIG. 1 etc. are only examples, and various modifications can be conceivable. For example, it is possible to form the circuit by reversing the conductivity type of the transistor while correspondingly reversing the positions of the power source terminal and the earth terminal. Also in this case, the fundamental operating principle is the same.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An organic EL display device comprising:
a pixel circuit on a first substrate; and
a touch detection circuit adjacent to the pixel circuit on the first substrate,
wherein the pixel circuit comprises:
an organic EL light-emitting element configured to emit light having brightness depending on a pixel voltage supplied by a pixel signal line;
a drive element configured to drive the organic EL light-emitting element; and
a first select element configured to supply the pixel voltage to the drive element in synchronization with a control signal supplied by a control signal line,
the touch detection circuit comprises:
a touch detection capacitor configured to detect a presence/absence of a touch of a dielectric; and
a second select element configured to output a signal indicative of the presence/absence of the touch of the dielectric detected by the touch detection capacitor to an electrostatic signal line in synchronization with the control signal supplied by the control signal line.

2. The device of claim 1, wherein the pixel signal line in the pixel circuit and the electrostatic signal line in the touch detection circuit are integrated.

3. The device of claim 1, wherein the touch detection circuit is adjacent to the pixel circuit in a first direction,
a length of the touch detection capacitor in a second direction orthogonal to the first direction is larger than a length of the touch detection capacitor in the first direction,
the touch detection capacitor is configured to be pre-charged in synchronization with a pre-charge signal supplied by a pre-charge signal line formed in the first direction,
a first distance is longer than a second distance, the first distance being a distance from the pre-charge signal line in the touch detection circuit to the pre-charge signal line in another touch detection circuit adjacent to the touch detection circuit in the second direction, the second distance being a distance from a first wire farthest from the touch detection circuit among wires formed in the second direction in the pixel circuit to a second wire farthest from the pixel circuit among wires formed in the second direction in the touch detection circuit.

4. An organic EL display device comprising:
a plurality of pixel circuits on a first substrate, each of the pixel circuits emitting different colored light; and
a touch detection circuit adjacent to one of the pixel circuits on the first substrate,
wherein each of the pixel circuits comprises:
an organic EL light-emitting element configured to emit light having brightness depending on a pixel voltage supplied by a pixel signal line;
a drive element configured to drive the organic EL light-emitting element; and
a first select element configured to supply the pixel voltage to the drive element,
in at least one of the pixel circuits, the pixel voltage is supplied to the drive element in synchronization with a first control signal supplied by a first control line, and
in at least another of the other pixel circuits, the pixel voltage is supplied to the drive element in synchronization with a second control signal supplied by a second control line,
the touch detection circuit comprises:
a touch detection capacitor configured to detect a presence/absence of a touch of a dielectric; and
a second select element configured to output a signal indicative of the presence/absence of the touch of the dielectric detected by the touch detection capacitor to an electrostatic signal line in synchronization with the first control signal supplied by the first control signal line.

5. The device of claim 4, wherein the touch detection circuit is adjacent to one of the pixel circuit in a first direction,
a length of the touch detection capacitor in a second direction orthogonal to the first direction is larger than a length of the touch detection capacitor in the first direction,
the touch detection capacitor is configured to be pre-charged in synchronization with a pre-charge signal supplied by a pre-charge signal line formed in a first direction,
the first and the second control signal lines and the pre-charge signal lines are formed in the first direction,
a first distance is longer than a second distance, the first distance being a distance from the pre-charge signal line in the touch detection circuit to the pre-charge signal line in another touch detection circuit adjacent to the touch detection circuit in the second direction, the second distance being a distance from a first wire farthest from the touch detection circuit among wires in the pixel circuit formed in the second direction to a second wire farthest from the pixel circuit among wires in the touch detection circuit formed in the second direction.

6. The device of claim 4, wherein the pixel signal line of at least one of the pixel circuits and the electrostatic signal line in the touch detection circuit are integrated.

7. The device of claim 6, wherein the pixel signal line of one of the pixel circuits adjacent to the touch detection circuit and the electrostatic signal line in the touch detection circuit are integrated.

8. The device of claim 4, wherein the signal indicative of the presence/absence of the touch of the dielectric is generated based on a voltage of a first terminal of the touch detection capacitor.

9. The device of claim 8, wherein the touch detection circuit comprises:
a third select element configured to pre-charge the touch detection capacitor in synchronization with a pre-charge signal supplied by a pre-charge signal line; and
a transistor configured to output a voltage depending on the first terminal of the touch detection capacitor, a control terminal of the transistor being connected to the first terminal of the touch detection capacitor.

10. An organic EL display device comprising:
a substrate;
a touch detection capacitor on the substrate configured to detect a presence/absence of a touch of a dielectric;
a first electrode on the substrate;
an organic EL light-emitting element on the first electrode; and
a second electrode on the organic EL light-emitting element and above at least a part of the substrate, the second electrode having an opening above the touch detection capacitor.

11. The device of claim 10 further comprising:
a drive element configured to drive the organic EL light-emitting element;
a first select element configured to supply a pixel voltage to the drive element; and
a second select element configured to output a signal indicative of the presence/absence of the touch of the dielectric detected by the touch detection capacitor to an electrostatic signal line in synchronization with the control signal.

12. The device of claim 10 further comprising a third electrode on the touch detection capacitor.

13. The device of claim 12, wherein a material of the third electrode is identical to a material of the first electrode.

14. The device of claim 10 further comprising:
a sealing glass above the second electrode; and
a circularly polarizing plate on the sealing glass,
wherein the touch detection capacitor is configured to detect the presence/absence of the touch of the dielectric to the circularly polarizing plate.

15. A method for detecting a touch of a dielectric using an organic EL display device comprising a touch detection capacitor, an organic EL light-emitting element, and a drive element configured to drive the organic EL light-emitting element, the touch detection capacitor, the organic EL light-emitting element and the drive element are formed on a first substrate, comprising:
pre-charging a first terminal of the touch detection capacitor by supplying a first signal; and
supplying a pixel voltage to the drive element and reading out a signal indicative of a presence/absence of the touch of the dielectric by supplying a second signal, the signal being based on a voltage of the first terminal.

16. The method of claim 15, wherein pre-charging the first terminal of the touch detection capacitor and a control terminal of the drive element is reset at a predetermined voltage by supplying the first signal.

17. The method of claim 15, wherein upon reading out the signal indicative of the presence/absence of the touch of the dielectric, a second terminal of the touch detection capacitor is supplied with a predetermined voltage.

18. The method of claim 15 further comprising supplying the pixel voltage to another drive element after supplying the first signal and before supplying the second signal.

19. The method of claim 15 further comprising supplying the pixel voltage to another drive element after supplying the second signal.

20. A method for detecting a touch of a dielectric using an organic EL display device comprising a touch detection capacitor, an organic EL light-emitting element, and a drive element configured to drive the organic EL light-emitting element, the touch detection capacitor, the organic EL light-emitting element and the drive element are formed on a first substrate, comprising:
pre-charging a first terminal of the touch detection capacitor and resetting a control terminal of the drive element at a predetermined voltage by supplying a first signal;
reading out a signal indicative of a presence/absence of the touch of the dielectric while supplying a predetermined voltage to a second terminal of the touch detection capacitor, by supplying a second signal the signal being based on a voltage of the first terminal; and
supplying a pixel voltage to the drive element by supplying a third signal.
